(19) United States
(12) Patent Application Publication
(10) Pub. No.: US 2013/0007768 A1
(43) Pub. Date: Jan. 3, 2013

(54) Atomic operations on multi-socket platforms

(76) Inventor: RAMAKRISHNA SARIPALLI, Cornelius, OR (US)

(21) Appl. No.: 13/175,832

(22) Filed: Jul. 2, 2011

(51) Int. Cl. G06F 9/46

(52) U.S. Cl. 719/317

(57) ABSTRACT

Methods and apparatus relating to atomic operations on multi-socket/multi-processor platforms are described. In one embodiment, a first agent (such as a processor core) is coupled to a second agent (such as an input/output device) via a link. A memory, coupled to the first agent, stores a device driver, corresponding to the second agent, and an operating system (OS) for the first agent. The OS detects an affinity mask that indicates which agents are to be quiesced for an atomic operation to be issued by the second agent. The agents identified by the affinity mask are then quiesced in response to receipt of the atomic operation from the second agent. Other embodiments are also disclosed and claimed.

### FIELD

The present disclosure generally relates to the field of electronics. More particularly, some embodiments relate to atomic operations on multi-socket platforms.

### BACKGROUND

Some computer systems are capable of executing operations in parallel or concurrently. Select operations in these computer system may have to be performed atomically, e.g., to avoid simultaneous use of a common resource. Atomicity is generally enforced by mutual exclusion.

One common interface used in computer systems is Peripheral Component Interconnect (PCI) Express (“PCIE”, in accordance with PCI Express Base Specification 3.0, Revision 0.5, August 2008). PCI Express specifies some atomic operations. To implement atomic operations issued by PCI Express devices on multi-processor platforms, one straightforward approach is to quiesce the whole platform to stop all I/O (input/output) traffic. This approach however results in serious degradation of available I/O bandwidth and results in increased latencies in completion of operations which may have no dependency on a pending atomic operation.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-2 and 4-5 illustrate block diagrams of embodiments of computing systems, which may be utilized to implement various embodiments discussed herein.

FIG. 3 illustrates a flow diagram in accordance with an embodiment of the invention.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

Some of the embodiments discussed herein may increase the efficiency and/or reduce overhead associated with implementing PCI Express atomic operations on multi-socket/multi-processor platforms (e.g., using point-to-point coherent interconnects such as QPI (Quick Path Interconnect)). For example, an embodiment increases efficiency and/or reduces overhead by reducing the total latency involved in starting and/or completing PCI Express atomic operations. Embodiments discussed herein are envisioned to be equally applicable to future platforms that use QPI coherent and non-coherent protocols on multi-protocol links. Also, available bandwidth on coherent interconnects may be increased.

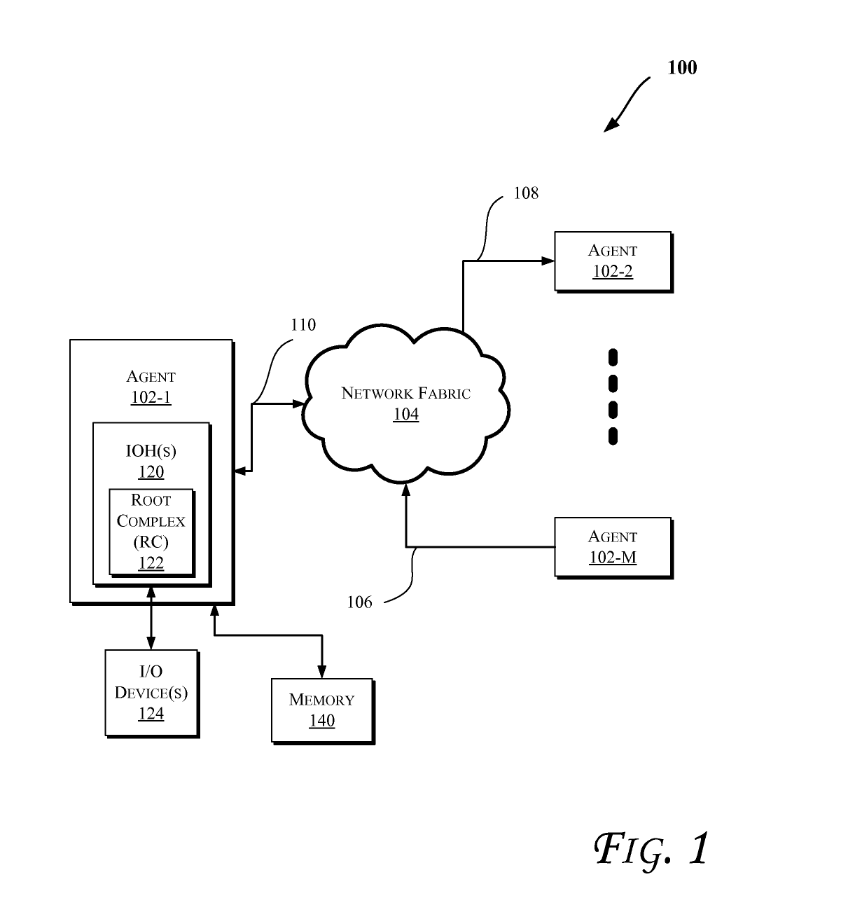

An embodiment provides application aware mechanisms to efficiently implement PCI Express atomic operations by eliminating the need to quiesce the complete fabric. For instance, one embodiment introduces the concept of targeted quiescing. As will be further discussed herein with reference to FIGS. 1-5, PCI Express devices and/or IOH (Input Output Hub) components may be modified. In addition, OS device driver APIs (Application Program Interfaces) may be modified in accordance with some embodiments.

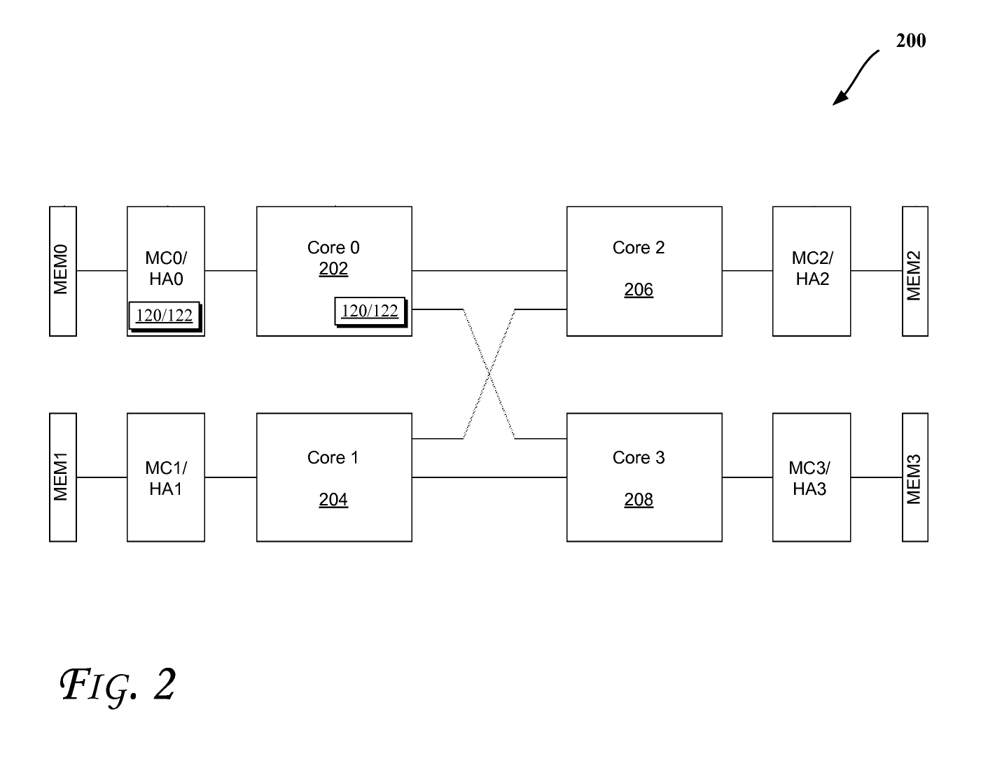

Various embodiments are discussed herein with reference to a computing system component, such as the components discussed herein, e.g., with reference to FIGS. 1-2 and 4-5. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, the agents 102 may be components of a computing system, such as the computing systems discussed with reference to FIGS. 2 and 4-5.

As illustrated in FIG. 1, the agents 102 may communicate via a network fabric 104. In an embodiment, the network fabric 104 may include one or more interconnects (or interconnection networks) that communicate via a serial (e.g., point-to-point) link and/or a shared communication network. For example, some embodiments may facilitate component debug or validation on links that allow communication with fully buffered dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

Also, in accordance with an embodiment, one or more of the agents 102 may include one or more IOHs 120 to facilitate communication between an agent (e.g., agent 102-1 shown) and one or more Input/Output (“I/O” or “IO”) devices 124 (such as PCI Express I/O devices). The IOH 120 may include a Root Complex (RC) to couple and/or facilitate communication between components of the agent 102-1 (such as a processor and/or memory subsystem) and the I/O devices 124 in accordance with PCI Express specification. In some embodiments, one or more components of a multi-agent system (such as processor core, chipset, input/output hub, memory controller, etc.) may include the RC 122 and/or IOHs 120, as will be further discussed with reference to the remaining figures.

As illustrated in FIG. 1, the agent 102-1 may have access to a memory 140. As will be further discussed with reference to FIGS. 2-5, the memory 140 may store various items including for example an OS, a device driver, etc.

More specifically, FIG. 2 is a block diagram of a computing system 200 in accordance with an embodiment. System 200 may include a plurality of sockets 202-208 (four shown but some embodiments may have more or less socket). Each socket may include a processor and one or more of IOH 120 and RC 122. In some embodiments, IOH 120 and/or RC 122 may be present in one or more components of system 200 (such as those shown in FIG. 2). However, more or less 120 and/or 122 blocks may be present in a system depending on the implementation.

Additionally, each socket may be coupled to the other sockets via a point-to-point (PtP) link, such as a Quick Path Interconnect (QPI). As discussed with respect the network fabric 104 of FIG. 1, each socket may be coupled to a local portion of system memory, e.g., formed by a plurality of Dual Inline Memory Modules (DIMMs) that may include dynamic random access memory (DRAM).

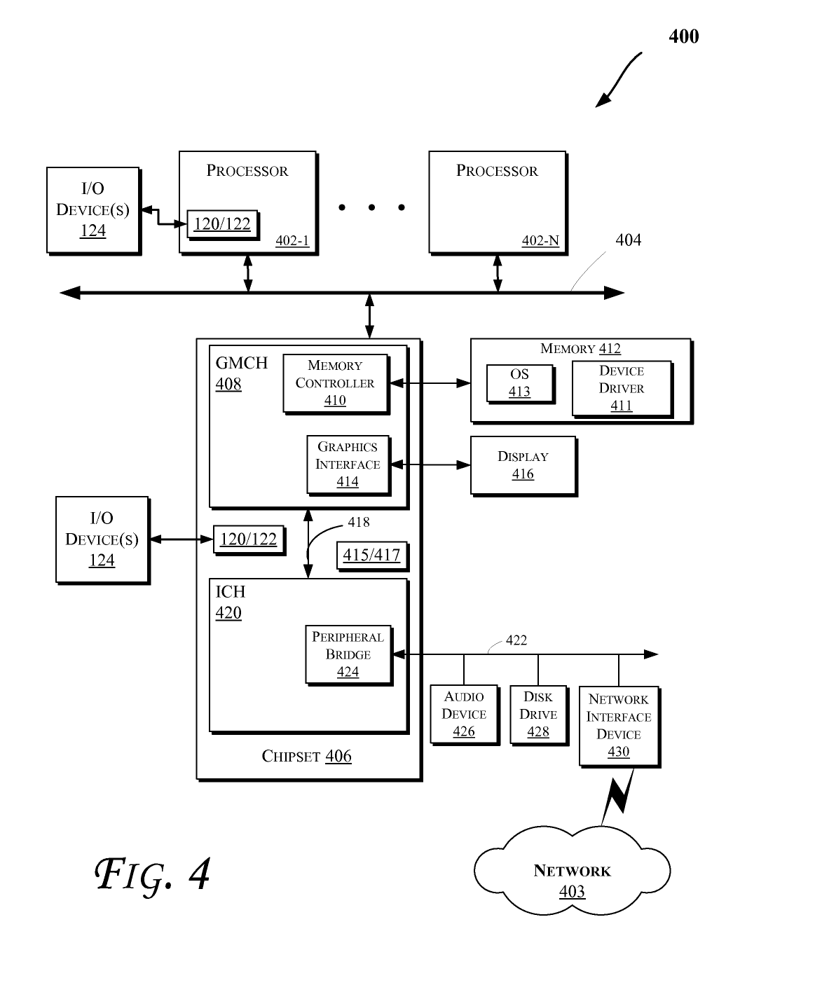

As shown in FIG. 2, each socket may be coupled to a Memory Controller (MC)/Home Agent (HA) (such as MC0/HA0 through MC3/HA3). The memory controllers may be coupled to a corresponding local memory (labeled as MEM0 through MEM3), which may be a portion of system memory (such as memory 412 of FIG. 4). In some embodiments, the memory controller (MC)/Home Agent (HA) (such as MC0/HA0 through MC3/HA3) may be the same or similar to agent 102-1 of FIG. 1 and the memory, labeled as MEM0 through MEM3, may be the same or similar to memory devices discussed with reference to any of the figures herein. Generally, processing/caching agents may send requests to a home node for access to a memory address with which a corresponding “home agent” is associated. Also, in one embodiment, MEM0 through MEM3 may be configured to mirror data, e.g., as master and slave. Also, one or more components of system 200 may be included on the same integrated circuit die in some embodiments.

Furthermore, one implementation (such as shown in FIG. 2) may be for a socket glueless configuration with mirroring. For example, data assigned to a memory controller (such as MC0/HA0) may be mirrored to another memory controller (such as MC3/HA3) over the PtP links.

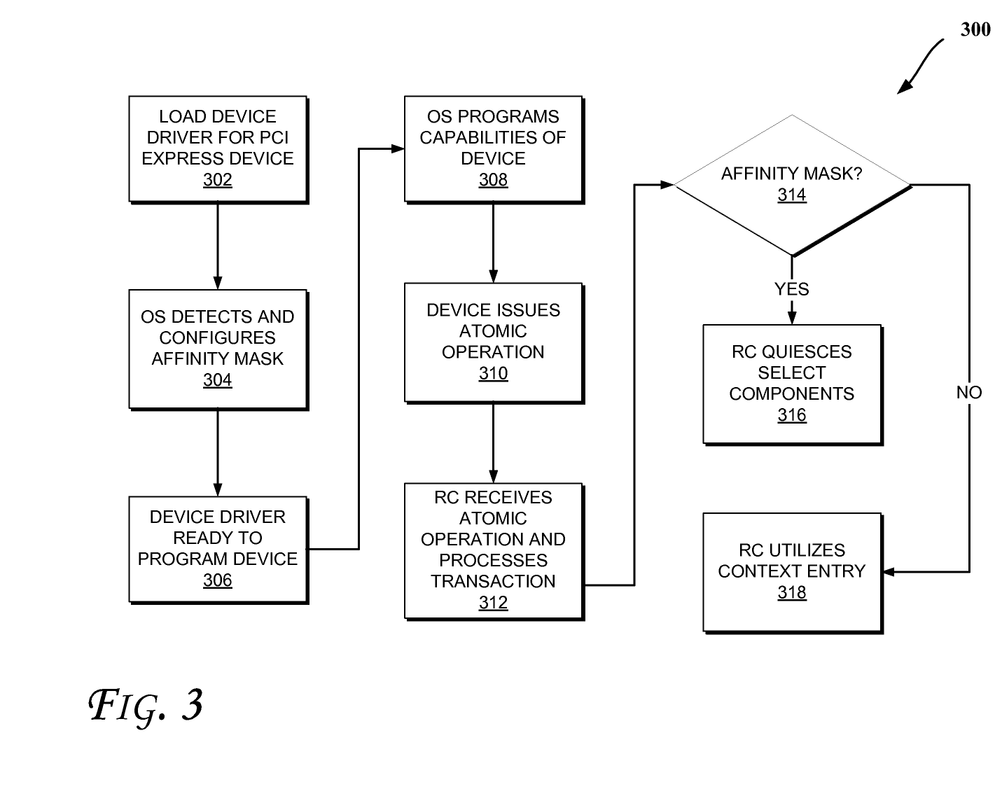

FIG. 3 illustrates a flow diagram of a method 300 to perform atomic operations in a multi-socket/multi-processor platform, according to an embodiment. For example, the method 300 may be performed on the systems discussed herein with reference to FIGS. 1-2 and 4-5. Also, one or more of the operations discussed with reference to FIG. 3 may be performed by one or more of the components discussed with reference to FIG. 1-2 or 4-5.

As shown in FIG. 3, at an operation 302 a device driver for a PCI Express device (such as device driver 411 of FIG. 4) may be loaded into memory (e.g., memory 412 of FIG. 4). At operation 302, the device driver may optionally configure its affinity mask (e.g., CPU set or set of other agents). The affinity mask information may be stored in various locations in the systems discussed herein. For example, the affinity mask may be stored in a memory device in the RC 122, memory 140, IOH 120, etc. or otherwise accessible by RC 122At an operation 304, an OS (such as OS 413 of FIG. 4) may detect the affinity mask (default or optionally configured by the device driver at operation 302) and configure the affinity mask in the context entry in the VT-d (Virtualization) remapping engine for the PCI Express function (such as in VT-d remapping engine 415 of FIG. 4). The VT-d remapping engine may utilize a translation table (e.g., table 417 of FIG. 4) to translate between physical and logical addresses for the PCI Express function. In an embodiment, it is expected that the OS will honor the affinity mask for the device driver code and data pages for the lifetime of the device driver (or alternatively for the time period associated with one or more transactions). If the OS expects to move the code and data pages of the device driver for a period spanning the issuance of one or more PCI Express atomic operations, the OS may program the complete platform affinity mask into the VT-d context entry for that PCI Express device.

At an operation 306, device driver gets ready to program its device to issue a PCI Express atomic operation. It may optionally inform the OS of this operation 306. In addition, the device driver may inform its device of its affinity mask for this particular operation (e.g., using a proprietary mechanism). At an operation 308, OS may use the information (provided to the device driver) to program the capabilities of the PCI Express device with the affinity mask for the atomic operation (e.g., using a standard mechanism).

At an operation 310, the PCI Express device may issue the PCI Express atomic operation, e.g., using a transaction ID (identifier) encoded in a previous message. More particularly, in some embodiments, before issuing the PCI Express atomic operation at operation 310, the PCI Express device issues a pre-defined PCI Express message (e.g., using route to RC encoding) indicating the CPU affinity mask for the incoming PCI Express atomic operation and the transaction ID it may use for the PCI Express atomic operation. The data in this PCI Express message may provide a hint to the RC regarding the data to use when processing the PCI Express atomic operation. In an embodiment, the CPU affinity mask is programmed by its device driver or the OS using standard or proprietary mechanisms. There may be no completion semantic/message associated with this message in one embodiment. Also the timing of operation 310 may depend on workload characteristics and other conditions present in the platform in some embodiments.

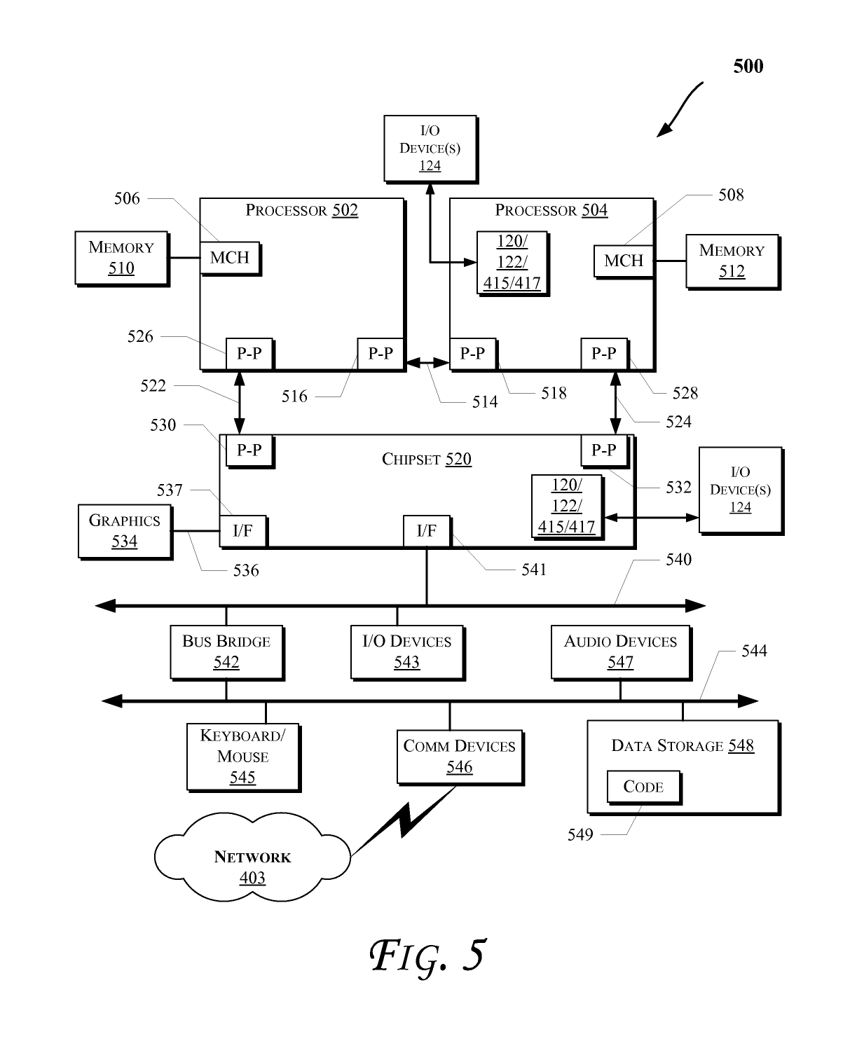

At an operation 312, the RC receives the PCI Express atomic operation and processes the transaction. At an operation 314, it is determined whether the transaction has an affinity mask (e.g., set by a previous PCI Express message request). An embodiment allows this data to be retained in a cache which is capable of tolerating/handling cache misses (such as the caches discussed with reference to FIGS. 4-5).

If the transaction has a corresponding affinity mask, at an operation 316, RC quiesces only those components (e.g., CPUs) that are identified in the affinity mask. In an embodiment, RC sends a targeted Quiesce message with the address range to each of the CPU in the affinity mask. There may be a completion semantic/message associated with this operation. Once all completions are received, the RC causes the operation(s) associated with the atomic operation to be performed. The RC may then restart the CPU identified in the affinity mask. While this is happening, other CPUs that are not part of the affinity mask may continue with their operations.

If no affinity mask corresponding to the transaction exists at operation 314, at an operation 318, RC consults the affinity mask using the context entry for this device in the VT-d remapping engine (which may be located in the Root Complex 122 in an embodiment). In turn, the RC quiesces only those CPUs that are identified in the affinity mask. In an embodiment, the operations performed here are the same as the operations in the YES path (see operation 316).

In some implementations, the device driver may specify the set of CPUs it intends to run on. In addition, the OS may configure the CPU affinity for a given device driver and associated software stack. The set of CPUs may be based on a variety of factors, such as for example NUMA (Non-Uniform Memory Architecture) configuration. Embodiments discussed herein do not propose any changes to this mechanism. In most server workloads, the affinity mask for the device driver may be a small subset of the total available CPUs (e.g., in order to take advantage of NUMA and other features). Furthermore, OS may program this affinity mask for the device driver instance into the VT-d context entry for the PCI Express device (e.g., based on its PCI Segment, Bus, Device, and function). In a hypervisor environment, the OS may have a private API to work with the hypervisor. In turn, HVM (High Volume Manufacturing) guests (non para-virtualized) with direct device assignment models may be supported automatically by the hypervisor. Accordingly, these changes may be made to the OS and the IOH including the extensions to the VT-d context entries, in accordance with one embodiment.

In an embodiment, the PCI Express device may use standard/PCI Express messages to inform the IOH/RC regarding the proposed target for PCI Express atomic operations. This allows the IOH to direct the future PCI Express atomic operations to the proper CPU set. The interface between the device driver and the PCI express device to configure the CPU set is implementation dependent but this is needed in order for the PCI Express device to be configured with the CPU set.

Accordingly, an embodiment implements PCI Express atomics in the IOH in a more efficient manner by not requiring complete shutdown of the traffic on the coherent interconnect (e.g., QPI). In particular, only the components that need to be involved in the flow of the PCI Express atomics transaction are quiesced. Additionally, other components may be sent a hint that the PCI Express atomics operation is currently in progress.

In various embodiments, one or more of the following components may be present: (1) CPU affinity mask of the device driver corresponding to a given PCI Express device is communicated by OS to the IOH that has the interface to the PCI Express device; (2) PCI Express device communicates to the IOH the target set of CPUs (on a per atomic transaction basis or over a specified lifetime); (3) Each IOH component in the platform (there may be more than one IOH in the platform) is capable of receiving PCI express messages from PCI Express devices indicating the potential affinity mask for future PCI Express atomic transactions; (4) VT-d context entries may be extended to support CPU affinity mask vector. An additional capability bit may be used to allow OS to discover this capability; (5) Quiesce messages sent by the IOH/quiesce master indicating the address range that is the target of the atomic operations; (6) A set of capability structures exposed by PCI Express devices that allow software to discover the capabilities and configure the affinity mask of the corresponding device driver (on a per transaction basis); and/or (7) Ability of each CPU (or Logical processor) to receive Quiesce messages (for a memory range) and block all operations targeting the memory range (on a cache line boundary).

By contrast, some legacy implementations may lack the following (as well as other features discussed herein but not enumerated here): (a) Co-location of the CPU affinity mask in the VT-d context entries for a given PCI Express device; (b) OS support for configuring CPU affinity mask of a device driver stack to the IOH/PCIe Root complex; (c) Ability of IOH to send targeted quiesce messages to home agents guarding the memory range that is the target of the PCI express atomics operation; (d) Ability of CPU agents (home or caching agents) to accept quiesce messages for a given memory range; (e) Ability of IOH to process proprietary (defined in accordance with one embodiment in an abstract fashion) PCI Express messages from PCI Express devices to configure the CPU mask for a given transaction flow.

Moreover, some PCI Express atomic operations are specified in PCI Express Base Specification 3.0. PCI Express atomics may include the following operations:

FetchAdd—Atomically read and add a specified value;

Unconditional Swap—Atomically swap a value with a memory location; and

CAS (Compare And Swap)—Request contains two operands; a compare value and a swap value.

Embodiments discussed herein are envisioned to support all the aforementioned types of PCI Express atomic operations.

In some embodiments, PCI Express atomic operations are expected to be used in accelerators, database engines, high performance application, and/or corresponding software stacks. In addition, database engines (e.g., embedded or otherwise) may take advantage of PCI Express atomic operations supported by NIC (Network Interface Card) PCI express devices (such as NIC device 430 of FIG. 4).

Further, the embodiments discussed herein may have no effect on the functionality of existing software stacks, atomic operations issued by the processor complex (for example, operations implemented using ProcLock, ProcSplitLock), and newer software stacks that may use PCI Express atomics and are expected to increase the performance by implementing software (e.g., device driver and/or OS (Operating System)) aware mechanisms to reduce the latencies involved.

FIG. 4 illustrates a block diagram of a computing system 400 in accordance with an embodiment of the invention. The computing system 400 may include one or more central processing unit(s) (CPUs) 402-1 through 402-N or processors (collectively referred to herein as “processors 402” or more generally “processor 402”) that communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

Also, the operations discussed with reference to FIGS. 1-3 may be performed by one or more components of the system 400. In some embodiments, the processors 402 may be the same or similar to the processors 202-208 of FIG. 2. Furthermore, the processors 402 (or other components of the system 400) may include one or more of the IOH 120, the RC 122, the VT-d remapping engine 415, and/or translation table 417. Moreover, even though FIG. 4 illustrates some locations for items 120/122/415/417, these components may be located elsewhere in system 400. For example, I/O device(s) 124 may communicate via bus 422, etc.

A chipset 406 may also communicate with the interconnection network 404. The chipset 406 may include a graphics and memory controller hub (GMCH) 408. The GMCH 408 may include a memory controller 410 that communicates with a memory 412. The memory 412 may store data, including sequences of instructions that are executed by the CPU 402, or any other device included in the computing system 400. For example, the memory 412 may store data corresponding to an operation system (OS) 413 and/or a device driver 411 as discussed with reference to the previous figures. In an embodiment, the memory 412 and memory 140 of FIG. 1 may be the same or similar. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

Additionally, one or more of the processors 402 may have access to one or more caches (which may include private and/or shared caches in various embodiments) and associated cache controllers (not shown). The cache(s) may adhere to one or more cache coherent protocols. The cache(s) may store data (e.g., including instructions) that are utilized by one or more components of the system 400. For example, the cache may locally cache data stored in a memory 412 for faster access by the components of the processors 402. In an embodiment, the cache (that may be shared) may include a mid-level cache and/or a last level cache (LLC). Also, each processor 402 may include a level 1 (L1) cache. Various components of the processors 402 may communicate with the cache directly, through a bus or interconnection network, and/or a memory controller or hub.

The GMCH 408 may also include a graphics interface 414 that communicates with a display device 416, e.g., via a graphics accelerator. In one embodiment of the invention, the graphics interface 414 may communicate with the graphics accelerator via an accelerated graphics port (AGP). In an embodiment of the invention, the display 416 (such as a flat panel display) may communicate with the graphics interface 414 through, for example, a signal converter that translates a digital representation of an image stored in a storage device such as video memory or system memory into display signals that are interpreted and displayed by the display 416. The display signals produced by the display device may pass through various control devices before being interpreted by and subsequently displayed on the display 416.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403). Other devices may communicate via the bus 422. Also, various components (such as the network interface device 430) may communicate with the GMCH 408 in some embodiments of the invention. In addition, the processor 402 and one or more components of the GMCH 408 and/or chipset 406 may be combined to form a single integrated circuit chip (or be otherwise present on the same integrated circuit die).

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 412 of FIG. 4. As shown in FIG. 5, the processors 502 and 504 may also include the cache(s) discussed with reference to FIG. 4.

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537.

At least one embodiment of the invention may be provided within the processors 502 and 504 or chipset 520. For example, the processors 502 and 504 and/or chipset 520 may include one or more of the IOH 120, the RC 122, the VT-d remapping engine 415, and/or translation table 417. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5. Hence, location of items 120/122/415/417 shown in FIG. 5 is exemplary and these components may or may not be provided in the illustrated locations.

The chipset 520 may communicate with a bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-5. Additionally, such computer-readable media may be downloaded as a computer program product, wherein the program may be transferred from a remote computer (e.g., a server) to a requesting computer (e.g., a client) by way of data signals transmitted via a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a first agent coupled to a second agent via a link;
a memory, coupled to the first agent, to store a device driver, corresponding to the second agent, and an operating system (OS) for the first agent,
wherein the OS is to detect an affinity mask that indicates which agents are to be quiesced for an atomic operation to be issued by the second agent and wherein the agents identified by the affinity mask are to be quiesced in response to receipt of the atomic operation from the second agent.

2. The apparatus of claim 1, wherein a root complex is to cause the agents identified by the affinity mask to be quiesced in response to receipt of the atomic operation from the second agent.

3. The apparatus of claim 1, wherein a root complex of the first agent is to transmit a targeted quiesce message to each of agents identified in the affinity mask and wherein, upon receipt of completion messages from each of the agents in the affinity mask responsive to the targeted quiesce message, the root complex is to cause the agents identified by the affinity mask to be quiesced.

4. The apparatus of claim 1, wherein agents that are not identified by the affinity mask are to continue with their operations without regard for the atomic operation.

5. The apparatus of claim 1, wherein the OS is to configure the affinity mask in a context entry of a virtualization remapping engine.

6. The apparatus of claim 5, wherein if no affinity mask corresponding to the atomic operation is detected, a root complex of the first agent is to access the context entry of the virtualization remapping engine.

7. The apparatus of claim 5, wherein the virtualization remapping engine is to access a translation table to perform address translation.

8. The apparatus of claim 1, wherein the first agent is to comprise one or more of: a processor core, a chipset, an input/output hub, or a memory controller.

9. The apparatus of claim 1, wherein the second agent is to comprise an input/output device.

10. The apparatus of claim 1, wherein the link is to comprise a point-to-point coherent interconnect.

11. The apparatus of claim 1, wherein the first agent is to comprise a plurality of processor cores and one or more sockets.

12. The apparatus of claim 1, wherein one or more of the first agent, the second agent, and the memory are on a same integrated circuit chip.

13. A method comprising:
detecting an affinity mask by an OS stored in a memory coupled to a first agent, wherein the affinity mask is to indicate which agents are to be quiesced for an atomic operation;
receiving the atomic operation issued by an I/O device coupled to the first agent, at a root complex of the first agent; and
causing the agents identified by the affinity mask to be quiesced in response to receipt of the atomic operation.

14. The method of claim 13, further comprising the root complex transmitting a targeted quiesce message to each of agents identified in the affinity mask.

15. The method of claim 14, wherein the root complex causing the agents identified by the affinity mask to be quiesced in response to receipt of completion messages from each of the agents in the affinity mask responsive to the targeted quiesce message.

16. The method of claim 13, further comprising the OS configuring the affinity mask in a context entry of a virtualization remapping engine.

17. The method of claim 16, further comprising the root complex accessing the context entry of the virtualization remapping engine if no affinity mask corresponding to the atomic operation is detected.

18. A computing system comprising:
a first processor core and an input/output device;
an input/output hub to couple the first processor core and the input/output device; and
a memory, coupled to the first processor core, to store a device driver, corresponding to the input/output device, and an operating system (OS) to run on the first processor core,
wherein the OS is to detect an affinity mask that indicates which agents of the computing system are to be quiesced for an atomic operation to be issued by the input/output device and wherein the agents identified by the affinity mask are to be quiesced in response to receipt of the atomic operation from the input/output device.

19. The system of claim 18, wherein a root complex, coupled to the first processor core, is to transmit a targeted quiesce message to each of agents identified in the affinity mask and wherein, upon receipt of completion messages from each of the agents in the affinity mask responsive to the targeted quiesce message, the root complex is to cause the agents identified by the affinity mask to be quiesced.

20. The system of claim 18, wherein the OS is to configure the affinity mask in a context entry of a virtualization remapping engine and wherein if no affinity mask corresponding to the atomic operation is detected, the root complex is to access the context entry of the virtualization remapping engine to process the atomic operation.
